(19) United States
(12) Patent Application Publication
(10) Pub. No.: US 2019/0366132 A1
(43) Pub. Date: Dec. 5, 2019

(54) HYDRAULIC RESCUE DEVICE FOR MANUAL OPERATION BY A RESCUER

(71) Applicant: Weber-Hydraulik GmbH, Losenstein (AT)

(72) Inventors: Ruediger Georg KNOLL, Buechelberg (DE); Milan KROFLIC, Mozirje (SI)

(73) Assignee: Weber-Hydraulik GmbH, Losenstein (AT)

(21) Appl. No.: 16/480,033

(22) PCT Filed: Mar. 9, 2018
(86) PCT No.: PCT/AT2018/060061

§ 371 Date: Jul. 23, 2019

(30) Foreign Application Priority Data
Mar. 10, 2017 (AT) A50190/2017

(51) Int. Cl. A62B 3/00

(52) U.S. Cl. CPC A62B 3/005

(57) ABSTRACT

The invention relates to a hydraulic rescue device (1) for manual operation by one rescuer. The rescue device (1) comprises a hydraulic cylinder (5) comprising a cylinder tube (6) and at least one piston rod (7, 7′) that can be adjusted relative to the cylinder tube (6), at least one first support surface (17) formed on the cylinder tube (6) for supporting the rescue device (1) in a load-transferring manner on first object surfaces that can be freely selected by a rescuer, at least one second support surface (19) for supporting the rescue device (1) in a load bearing manner on second object surfaces that can be freely selected by a rescuer, and at least one manually operable control valve (14). At least one or more markings (23, 23′) are provided on the casing surface (22, 22′) of the at least one piston rod (7, 7′), which at least one marking (23, 23′) is provided at least to signal a remaining stroke (24) that is still available and/or an adjusting stroke (25) already travelled of the at least one piston rod (7, 7′) relative to the cylinder tube (6).

The invention relates to a hydraulic rescue device for manual operation or use by at least one rescuer. The hydraulic rescue device can thereby be carried or positioned manually by the rescuer. The hydraulic rescue device comprises a hydraulic cylinder comprising a cylinder tube and at least one piston rod that can be adjusted relative to the cylinder tube. At least one first support face formed on the cylinder tube is provided for supporting the rescue device in a load-transferring manner on first object surfaces that can be freely selected by a rescuer. At least one second support surface formed on the at least one piston rod is provided for supporting the rescue device in a load-transferring manner on second object surfaces that can be freely selected by a rescuer, for example on a vehicle body or another object. At least one control valve that can be operated manually serves the optional initiation and termination of adjusting movements of the at least one piston rod relative to the cylinder tube.

Such hydraulic rescue devices are used mainly by disaster-relief teams or other aid organizations, such as fire fighters, in order to be able to free accident victims from deformed vehicles or from other trapped or jammed situations. These rescue devices are particularly applied in order to force jammed doors open or lift or push away other interfering objects in the area of the accident victim. In many cases, this is what actually makes it possible to free trapped or jammed persons or to create sufficient space around the victim in order to accomplish a recovery from the respective setting, for example from a passenger compartment of a passenger car or lorry, from a building structure or the like. In some cases, this requires massive hydraulic positioning cylinders and sufficiently large hydraulic docking forces in order to generate the respective positioning forces. This requires sufficiently powerful hydraulic aggregates and correspondingly stable and sufficiently adjustable hydraulic cylinders with corresponding hydraulic and mechanical capacity. The traversing speed of the at least one piston rod of such hydraulic rescue devices is limited in terms of technology. In particular, there are technical limitations regarding adjusting speed as well as adjusting stroke due to the limited capacity of the required pump or, respectively, hydraulic aggregates, the limited oil volumes and the ultimately resulting positioning forces, positioning speeds and positioning width. Especially when recovering or rescuing injured persons, a decisive criterion is that the respective rescue or recovery operation can be carried out as quickly and as effectively as possible.

The present invention is based on the object of developing a class-specific hydraulic rescue device in such a way that a quick and efficient or, respectively, targeted rescue of injured persons can be aided or, respectively, achieved in the most reliable possible way.

The object of the invention is achieved by a class-specific, hydraulic rescue device with the characterizing features of claim 1.

A hydraulic rescue device according to the invention comprises at least one marking on the casing surface of the at least one piston rod, which can be read by a rescuer, which marking or markings is or are provided to signal a remaining stroke and/or to signal the adjusting stroke of the at least one piston rod already travelled with respect to the cylinder tube.

One advantage of the hydraulic rescue device according to the invention is that it can be used to carry out rescue procedures in a particularly targeted or, respectively, efficient way. In particular, the markings that can be read and interpreted by the rescuer make it possible to take consideration or caution of the technical limitations of the rescue device in time or at an early stage. In particular, the rescuer can implement the corresponding rescue cylinder at an early stage or, respectively, apply it at a better suited position in order to create the required rescue opening or to create the necessary space to rescue the correspondingly injured person. This can save valuable time in the course of a rescue operation for injured persons. Apart from that, it can keep errors or misjudgments of the rescuer to a minimum. There can, for example, be no irritations when the hydraulic rescue cylinder is already extended to a maximum, but the rescuer believes that further adjusting stroke is still available. Such standstills or blockages in the rescue process can have serious consequences. These fatal consequences can in particular be avoided or minimized by the measures of the invention in combination with the hydraulic rescue device. This means that the rescue process can be carried out as quickly, unmistakably and in as highly targeted a way as possible, which is advantageous both for the corresponding rescuer or can be particularly advantageous for the person that is to be freed.

According to a suitable embodiment, the markings on the at least one piston rod comprise measurements, in particular numerical values and/or measurement units, which measurements indicate the remaining stroke of the at least one piston rod that is still available. This means that the rescuer keeps a clear overview of the adjusting distance or adjusting stroke that is still available and of whether this remaining stroke that is still available is sufficient in order to achieve a sufficiently large rescue opening or a sufficiently large displacement or pressure path. Otherwise, the rescuer can take measures at an early stage or, respectively, in time, for example reposition the rescue device or install intermediate devices or extension pieces in order to move the rescue process forward quickly or to conclude it.

According to a combined or alternative embodiment it can be provided that the markings comprise arrow-shaped, bar-shaped or cuneiform symbols, which symbols represent the remaining stroke of the at least one piston rod that is still available. One advantage of this embodiment is that relatively largely dimensioned symbols can be applied which clearly indicate in which operating state the hydraulic rescue device is in each case. Moreover, it facilitates a representation and detection of the remaining stroke still available in each case regardless of language or country. Moreover, such symbols can be detected comparatively more easily or more reliably than this can usually be achieved with signs or other measurements or values.

According to an alternative or combined embodiment, the markings are provided for signaling the remaining stroke of the at least one piston rod that is still available in terms of value or amount and/or for signaling the adjusting stroke of the at least one piston rod already travelled with respect to the first support surface at the cylinder tube. This also helps the rescuer get an overview of what remaining path or adjusting distance is still available in order to be able to swiftly conclude the rescue operation or to be able to bring about the corresponding rescue opening. If the respectively travelled adjusting stroke is, however, indicated, the remaining stroke can simply be determined or evaluated by the rescuer in relation to the maximum available adjusting stroke. The indicated measures allow for better planning of a rescue mission after the rescuer receives a signal in plain text and/or as a symbol as to the available stroke or, respectively, push reserve.

According to one embodiment, the markings comprise marker rings or line marks extending at least partially across the circumference of the cross-section or casing of the at least one piston rod. The advantage of this is that such markings can be produced easily and quickly and that these labels can provide clear information on the respective operative or system state of the hydraulic rescue device. Other than that, this means that the corresponding status information with regard to the rescue device or, respectively, its at least one piston rod can be clearly detected from almost all perspectives.

According to another embodiment it can be provided that at least two, preferably at least three and a maximum of five identically designed markings are indicated with respect to the cross-sectional or casing circumference of the at least one piston rod, which are equally spread across the cross-sectional or casing circumference. This also means that the corresponding marking can be detected or read by the rescuer from almost all perspectives without changes in the position of the rescue device and/or the rescuer being required. In particular, this means that the corresponding information can easily be detected. Furthermore, it means that markings that are cost-intensive or might compromise the surface of the at least one piston rod are avoided. It can, in particular, minimize excessive processing or, respectively, keep cost-incurring marking steps at an ideal cost-benefit ratio.

It is also expedient that several markings are formed spaced apart with respect to the longitudinal axis of the at least one piston rod. The rescuer can thus find out the adjusting stroke that is still available at an early stage or in time. In particular, quasi continuous or accompanying information is thus available to the rescuer while using the hydraulic rescue device. Contrary to markings that are only formed on the last terminal portion of the at least one piston rod, the corresponding rescue operation can thus be carried out in a particularly targeted and well-considered, or, respectively, efficient manner, and, in particular, the corresponding use of the hydraulic rescue device can be planned precisely.

Good readability and the avoidance of leakages in the course of the use of the hydraulic rescue device can be accomplished if the markings are formed by signs, symbols and/or values that are designed in contrasting colors and flush-mounted with regard to the surface of the at least one piston rod. In contrast to stampings or embossed grooves in the surface of the at least one piston rod, equally high densities can be achieved and leakages can be avoided in this manner. In particular, the formation of an excessive oil film on the casing surface or, respectively, the surface of the at least one piston rod can be minimized.

One practical measure is to form the markings with annealing colors, which annealing colors are applied to metallic surface sections of the at least one piston rod by thermal impact and are in particular produced by laser beam processing. Thus, the corresponding markings can be applied to the corresponding surface sections of the piston rods relatively cheaply and also quickly. In particular, this means that the corresponding markings can be formed in an economical manner. However, the corresponding markings are also long-lasting or, respectively, highly durable without the corresponding surface sections of the at least one piston rod being compromised by them.

An alternative marking measure is also expedient, according to which the markings are applied to metallic surface sections of the at least one piston rod by means of electrochemical, in particular by means of galvanic processing methods. Such methods can also be used to mark or label the at least one piston rod in a long-lasting manner without resulting in a substantial deterioration of the quality of the corresponding surface sections.

According to one feasible embodiment it is provided that the hydraulic rescue device has a maximum available adjusting range between 300 mm and 1000 mm and the markings are arranged at a distance of 50 mm or 100 mm with regard to the longitudinal direction of the at least one piston rod. This makes it possible to create an optimized ratio between performance and light weight or, respectively, easy handling. In addition, a number of typically occurring rescue scenarios can thus be covered, in particular in relation to car accidents. Furthermore, an ideal ratio between clarity and informative value or depth of information is achieved if the markings are arranged at a distance of between 50 and 100 mm. In particular, this means that an operator is provided with sufficient information as to what thrust effects can still be achieved with the hydraulic rescue device. This particularly creates an optimized ratio between the labelling expenses and sufficient information for the respective rescuer.

According to an advantageous development it can be provided that a comparatively higher density of markings or a higher distance resolution of the markings is provided for the remaining stroke in the last section of the total available adjusting stroke compared to the initial section of the total available adjusting stroke of the at least one piston rod. In particular, this results in a higher resolution of the final distance compared to the initial distance. This offers the advantage that when the adjusting limit of the hydraulic rescue device is reached or is about to be reached, a higher information depth or a finer resolution of the adjusting distance that is still available is at hand in order to make it easier for the respective rescuer to decide whether a repositioning should be carried out, whether extension parts or additional support parts should be interposed or whether the remaining available adjusting path is sufficient for achieving the desired goal.

For a better understanding of the invention, it is explained in more detail by means of the following embodiments.

In a highly simplified, schematic representation, the figures show the following:

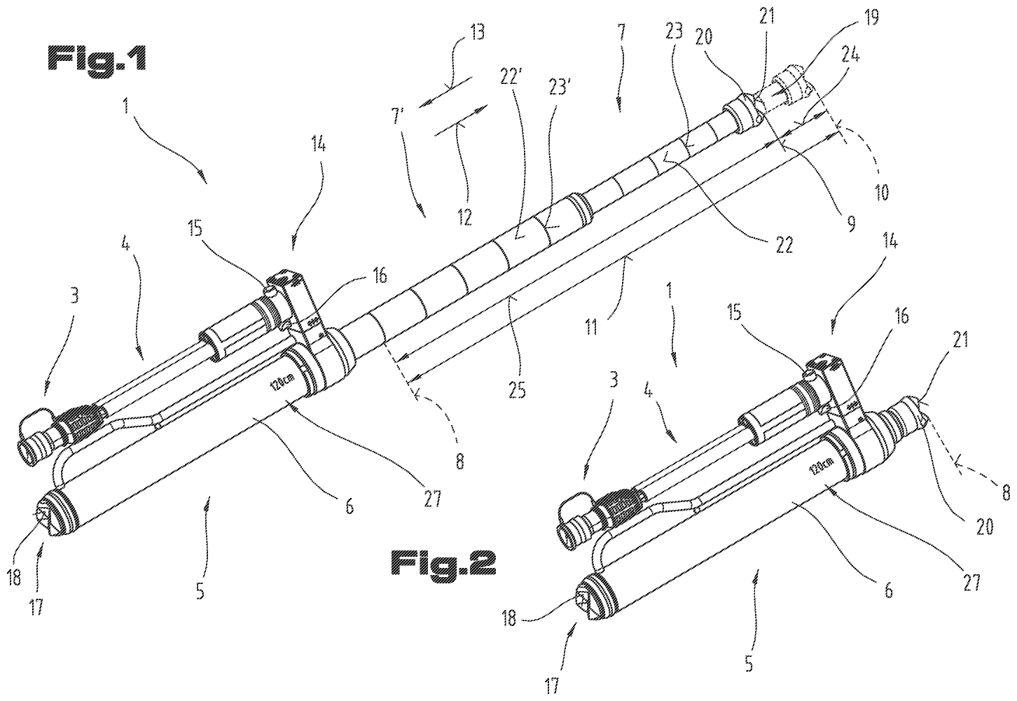

FIG. 1 a hydraulic rescue cylinder in an at least partly extended position of the at least one piston rod in a perspective view;

FIG. 2 the rescue cylinder according to FIG. 1 in a state with the at least one piston in a retracted position;

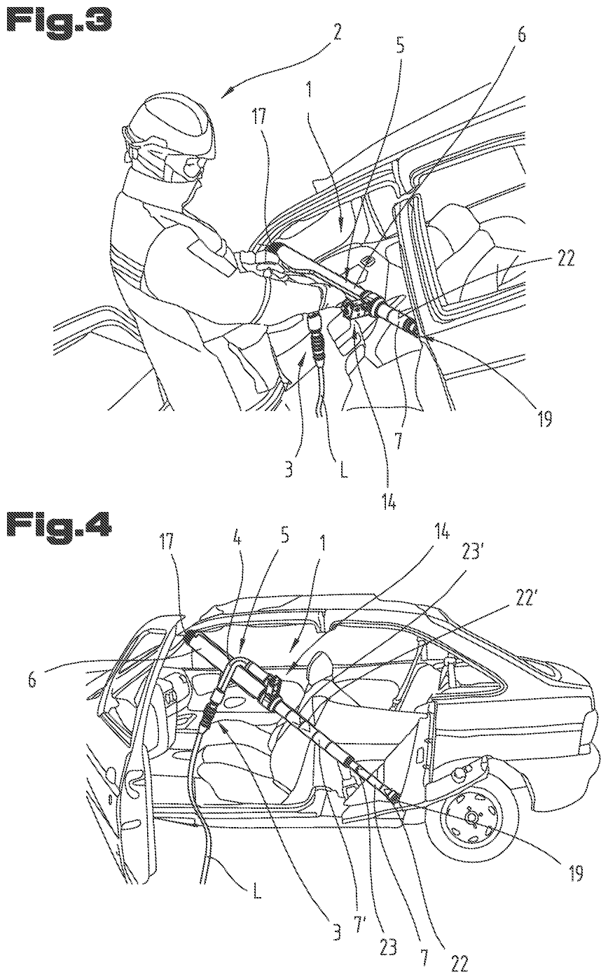

FIG. 3 the rescue cylinder according to FIG. 1 in an exemplary operating situation while being used by a rescuer;

FIG. 4 the rescue cylinder according to FIG. 3 in the course of its intended use;

FIG. 5 an embodiment for markings on the piston rod of the rescue cylinder;

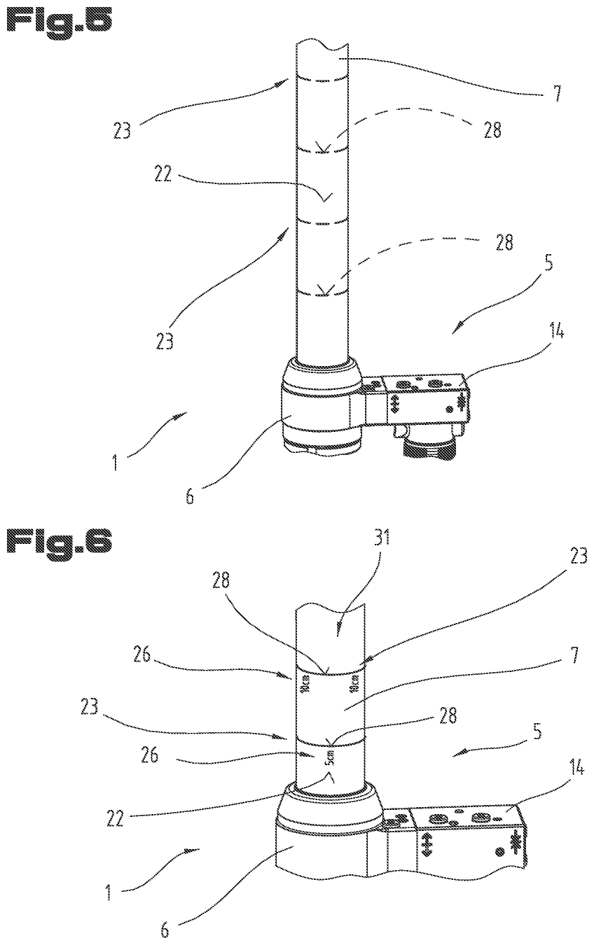

FIG. 6 another embodiment for markings on the piston rod of the rescue cylinder;

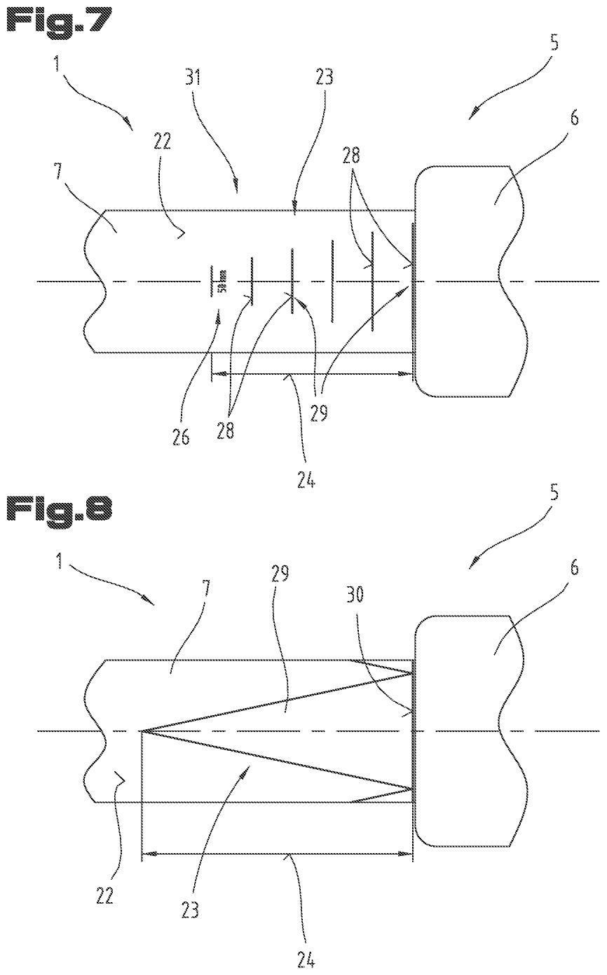

FIG. 7 an embodiment for markings in the last section of the maximum available adjusting stroke of the rescue cylinder;

FIG. 8 another embodiment for markings in the last section of the maximum available adjusting stroke of the rescue cylinder;

Initially it should be noted that identical parts are indicated with the same reference numbers or component designations in the various described embodiments, with the disclosures contained in the entire description being transferable analogously to the same parts with the same reference numbers or component designations. Furthermore, the position data chosen in the description such as up, down, lateral and so on, refer to the directly described and depicted figure and this position data can analogously be transferred to the new position if the position is changed.

FIGS. 1 through 4 illustrate an embodiment of a hydraulic rescue device 1 designed according to the invention. This preferably hydraulically driven rescue device 1 is provided for hydraulic operation or use by a rescuer 2, typically an employee of a disaster relief team or by a member of the fire brigade. The hydraulic rescue device 1 is thereby designed in such a way with regard to its total mass that it is portable or mobile, in particular in such a way that it can be actuated or taken to the operation site by only one rescuer 2. If necessary, hydraulic rescue devices 1 may also be implemented where handling or efficient use by two or more rescuers is required or expedient.

The rescue device 1 represented by way of example is provided for use in combination with an external hydraulic aggregate or pump aggregate, which is not depicted here. In this context, the rescue device 1 comprises at least one coupling device 3 for an optional releasable connection between a hydraulic line L, which is as flexible in shape as possible and schematically depicted in FIGS. 3, 4, and an external or separately positioned hydraulic or pump aggregate. This coupling device 3 is hereby implemented as a hydraulic plug coupling in order to be able to optionally create or separate a fluidic connection between the rescue device 1 and the hydraulic aggregate 1 or its tube-like hydraulic line L. The hydraulic line L preferably comprises a so-called pressure line and a return line for the hydraulic fluid, which lines either run in parallel or can also be configured coaxially to one another.

The at least one hydraulic or mechanic-hydraulic coupling device 3 can—as depicted—be connected to a hydraulic cylinder 5 of the rescue device 1 via a line connection 4 that is at least partly flexible in terms of shape. The hydraulic cylinder 5 represents the primary or basic component of the rescue device 1. This tube-like line connection 4 at the hydraulic rescue device 1 usually has a length of less than one meter. This offers advantages in terms of the achievable ergonomics and versatility of the hydraulic rescue device 1.

It is alternatively also possible to implement the mechanic hydraulic coupling device 3 rigidly or in a fixed position at the hydraulic cylinder 5 or at a connection interface formed thereon. Alternatively, it is also possible to provide for a permanent, in particular a non-releasable hydraulic connection or a hydraulic connection between the rescue device 1 or between its hydraulic cylinder 5 and an external hydraulic aggregate that can only be released using tools. It is also possible to structurally combine the rescue device 1 with a hydraulic aggregate or a pump aggregate, and in particular to combine them into one structural unit. In this case, in particular a battery-driven hydraulic aggregate can be a fixed or optionally releasable component of the mobile rescue device 1. Alternatively, the electric energy supply of such a structurally combined rescue device 1 can also be provided based on an external power source, with only a cable connection being provided between said external power source and the hydraulic rescue device 1.

It is essential that an optimum ratio between the light weight or portability and the attainable capacity in particular the attainable adjusting force and/or the adjusting speed of the hydraulic cylinder 5 is achieved in the context of the hydraulic cylinder 5 and the corresponding drive unit for the hydraulic cylinder 5. In particular, the handling and the capacity of the hydraulic rescue device 1 should be at an optimum ratio, for the purpose of which compromises must be made in some cases with regard to pump or hydraulic capacity and the capacity of the hydraulic cylinder 5. The hydraulic aggregate thereby comprises a high-pressure hydraulic pump, which can be driven by a combustion engine or by an electric motor, which electric motor can be supplied by a power grid, a generator with a combustion engine or by a battery with electric operating power. The externally or internally implemented pump or hydraulic aggregate can thereby provide hydraulic pressures of up to 700 bar or more.

The hydraulic cylinder 5 of the rescue device 1 comprises a cylinder tube 6 and at least one piston rod 7, 7′ that is adjustable relative to the cylinder tube 6 in a manner that is, as such, known. In particular, at least one piston rod 7, 7′ is provided which is implemented as linearly adjustable relative to the cylinder tube 6. In this regard, the at least one piston rod 7, 7′ can be transferred from a starting or idle position 8 that is at least partially retracted into the cylinder tube 6 (FIG. 2) to at least one operating position 9 (FIG. 1), which at least one operating position 9 is between the starting or idle position 8 and an end or maximum position 10 that is limited due to structure. In this end or maximum position 10 that is illustrated by dashed lines in FIG. 1 the at least one piston rod 7, 7′, which is adjustable relative to the cylinder tube 6, is extended to the maximum and—as is known per se—is technically limited with respect to a further extension or adjusting movement away from the cylinder tube 6 by mechanical blocks or by other structural measures, such as shut-off valves or control-related end position limitations. The structurally limited extension length or the maximum available adjusting distance between the starting or idle position 8 of the hydraulic cylinder 5 or of its at least one piston rod 7, 7′ and the end or maximum position 10 of the hydraulic cylinder 5 of its at least one piston rod 7, 7′ thereby defines a technically maximum available or a maximum achievable adjusting stroke 11 of the rescue device 1, in particular of its hydraulic cylinder 5 or piston rod 7, 7′ in terms of structure.

This maximum adjusting stroke 11, which is the maximum available for the rescue device 1 or is the maximum available for the rescuer 2, depends primarily on the axial length of the cylinder tube 6 or on the latter's available axial length of the cylindric cavity, on the implementation or number of piston rods 7, 7′, on the transverse rigidity or kink stability of the hydraulic cylinder 5 and on other structural measures and stability requirements. In the depicted embodiment, the hydraulic cylinder 5 is embodied as what is called a telescope cylinder in which two telescopically adjustable piston rods 7, 7′ are provided as an example. In this regard, it is also conceivable to provide more than two piston rods 7, 7′ or to adjustably extend only one piston rod 7 relative to the cylinder tube 6. The depicted hydraulic cylinder 5 in a telescopic implementation offers the advantage that a relatively large maximum adjusting stroke 11 can be achieved in spite of a relatively short axial length of the cylinder tube 6.

The hydraulic cylinder 5 of the rescue device 1 can, in principle, be implemented as a single-acting hydraulic cylinder 5 in which the at least one piston rod 7, 7′ is extended relatively to the cylinder tube 6 due to the introduction of hydraulic fluid into the cylinder tube 6, and that can be transferred to another operating position 9 or to the end or maximum position 10, in particular starting from the starting or idle position 8 or starting from any operating position 9. The return to the starting or idle position 8 or a to a modified operating position 9 can be achieved by way of external force, for example by way of push movement by the rescuer 2, by gravity, by loading with an object or by way of a return spring. A return of the at least one piston rod 7, 7′ based on spring force is expedient in particular with regard to a single-acting hydraulic cylinder 5.

Preferably, however, the hydraulic cylinder 5 of the rescue device 1 is implemented as a double-acting hydraulic cylinder 5, in which both an extension movement—arrow 12—as well as a retraction movement—arrow 13—of the at least one piston rod 7, 7′ relative to the cylinder tube 6 can be achieved or initiated by means of hydraulic pressure, in particular using the hydraulic or pump function of the hydraulic aggregate that is not depicted here. In this context, hydraulic fluid is introduced and drained in a targeted manner with respect to the hydraulic cylinder 5.

When the hydraulic cylinder 5 is implemented as a double acting cylinder, a rescuer 2 can quickly and conveniently carry out activatable and deactivatable, bidirectional adjusting movements, i.e. alternative extension and retraction movements of the at least one piston rod 7, 7′ relative to the cylinder tube 6 if necessary. To control the corresponding adjusting movements, in particular the extension movement 12 and/or the retraction movement 13, at least one manually operable control valve 14 is provided on the rescue device 1, in particular on the hydraulic cylinder 5. Said manually operable control valve 14 comprises at least one actuating member 15, 16 by means of which extension movements 12 and/or retraction movements 13 of the at least one piston rod 7, 7′ can be initiated or finished. By way of example, two actuating members 15, 16 are provided on the hydraulic control valve 14. The actuating members 15, 16 are implemented as push buttons or push keys. The first actuating member 15 thereby serves to initiate retraction movements, while the other actuating member serves to initiate extension movements 12. Instead of the implementation of push buttons, it is also possible to form the actuating members 15, 16 by means of rocker keys, by means of sliding members, by means of one or more control dials and the like so as to facilitate a manually switching operation or a proportionally controlled actuation of the control valve 14.

At least one first support surface 17 is formed on the cylinder tube for supporting the rescue device 1 in a load-transferring manner on first object surfaces that can be freely selected by a rescuer 2. By way of example, the at least one first support surface 17 is provided at the end of the cylinder tube 6 facing away from the extendable piston rods 7, 7′. Alternatively or in combination therewith, it can be provided that at least one support surface is formed on the casing surface of the cylinder tube 6, in particular by at least one support bracket or another projection on the casing surface of the cylinder tube 6. It is also possible to provide step-like or tiered support surfaces 17 at the end face and/or near the casing surface of the cylinder tube 6. In order to support the rescue device on various object surfaces, for example on vehicle or bodywork surfaces, in the most slip-resistant manner possible, it can be provided that the at least one first support surface 17 comprises a slip-resistant profile 18 and/or friction-enhancing surfaces, for example consisting of an elastomer or other plastic material. Instead of a strongly contoured profile 18, at least one of the first support surfaces 17 can also feature increased surface roughness or an increased friction coefficient, for example by means of finely structured stampings or by means of coatings containing friction-enhancing granulation. Such profiles 18 or the other friction-enhancing measures should minimize undesired slipping of the rescue device 1, in particular of the cylinder tube 6, with regard to the respective object surfaces.

Furthermore, at least one second support surface 19 is formed at the at least one piston rod 7, 7′ for supporting the rescue device 1 in a load transferring manner on second object surfaces that can be freely selected by the rescuer 2. The at least one second support surface 19 is preferably formed at the end of the at least one piston rod 7, 7′ facing away from the cylinder tube 6 or distal end. Typically, the free or projecting end face of the outermost piston rod 7 is implemented as the support surface 19. As an example, support surface 19 is implemented at a preferably rotatably mounted pressure piece 20. Said second support surface can, in turn, exist several times, can in particular be implemented in a step-wise or incremental way in order to facilitate better adjustment to different operating conditions and/or have a profile 21 to enhance the slip-resistance of the at least one second support surface 19 or the entire rescue device 1 with respect to an object surface. Alternatively or in combination with such a profile 21, friction-enhancing measures in the context of the second support surface can also be provided, such as elastomer sections with increased surface roughness and the like.

As best shown in FIGS. 3, 4, the first support surface 17 and the second support surface 19 can be provided for support or force transmission with respect to object surfaces of a vehicle involved in an accident, in particular with respect to a vehicle body. In this context, separate support shoes or other force transmission elements or coupling tools can also be provided in order to be able to achieve an even better, slip-resistant support of the hydraulic rescue device 1 and to be able to perform or achieve a reliable and efficient force transmission from the rescue device 1 to the respective object, in particular to the respective object surfaces or body-work parts.

As can best be gathered from a synopsis of FIGS. 1, 3 and 4, it is expedient if at least one marking 23, 23′ is formed on the surface, in particular on the casing surface 22, 22′ of the at least one piston rod 7, 7′, in particular several markings 23, 23′, which at least one marking 23, 23′ is provided at least to signal a remaining stroke 24 of the at least one piston rod 7, 7′ that is still available with respect to the cylinder tube 6. Alternatively or in combination therewith, it can furthermore be provided that the at least one marking 23, 23′ is provided to signal a respectively travelled adjusting stroke 25 of the at least one piston rod 7, 7′ relative to the cylinder tube 6, in particular relative to the nearest end face of the cylinder tube 6, relative to the starting or idle position 8 of the at least one piston rod 7, 7′ or relative to the first support surface of the cylinder tube 6. The markings 23, 23′ on the at least one piston rod 7, 7′ can thereby be read by a rescuer 2 during the intended use or in the course of the operation of the hydraulic rescue device 1, in particular they can be visually detected and can be interpreted by the rescuer 2 at least with regard to the remaining stroke 24 of the hydraulic cylinder 5 that is still available. The remaining stroke 24 is thereby the adjusting distance of the hydraulic cylinder 5 or its at least one piston rod 7, 7′ that remains available based on its current operating position 9 in the direction of the maximum possible or impact-limited end or maximum position 10. The remaining stroke 24 is therefore at its maximum based on a starting or idle position 8 of the at least one piston rod 7, 7′, while the remaining stroke 24 that is still available steadily decreases with the increasing extension movement 12 of the at least one piston rod 7, 7′, and which remaining stroke 24 ultimately assumes or has the value zero when the end or maximum position 10 of the at least one piston rod 7, 7′ is reached.

The remaining stroke 24 is thus a measure of length that depends on the respective operating state or on the respective operating situation or operating position 9 of the at least one piston rod 7, 7′ or varies accordingly between the value “zero” and the maximum available adjusting distance or adjusting stroke 11 of the hydraulic cylinder 5, or on the latter's at least one piston rod 7, 7′ that can be adjusted relative to the cylinder tube 6. The fixed markings 23, 23′ on the at least one piston rod 7, 7′ therefore directly or indirectly indicate or signal the remaining stroke 24 that is still available in the course of extension or ejection movements 12 with respect to the cylinder tube 6.

Preferably, the remaining stroke 24 of the hydraulic cylinder 5 that is still available is signaled or illustrated to a rescuer 2 by means of a plurality of markings 23, 23′ on the casing surface 22, 22′ of the at least one piston rod 7, 7′. According to a technically equivalent embodiment or according to a combined embodiment for indicating the remaining stroke 24, it can also be provided that the markings 23, 23′ or additional labels or other designations on the casing surface 22, 22′ of the at least one piston rod 7, 7′ are provided for signaling the respectively travelled adjusting stroke 25 of the at least one piston rod 7, 7′ with respect to the cylinder tube 6. In this regard, markings 23, 23′ means individual markings or groups of markings spaced apart in the longitudinal direction of the at least one piston rod 7, 7′, which represent or signal the remaining stroke 24 that is still available and/or the adjusting stroke 25 of the at least one piston rod 7, 7′ that has already been travelled.

The markings 23, 23′ can be provided on all piston rods 7, 7′ in the event of a telescopic hydraulic cylinder 5 or only one of the piston rods 7, 7′, in particular on the piston rod 7′ with the comparatively larger or maximum diameter. As schematically depicted in FIG. 5, the markings 23 can be distributed or offset relative to the circumferential direction of the casing surface 22.

According to an expedient embodiment as illustrated by way of example in FIG. 6, the corresponding designations or markings 23 on the surface or casing surface 22, 22′ of the at least one piston rod 7, 7′ can comprise various measurements 26, which measurements 26 indicate the remaining stroke 24 of the at least one piston rod 7,7′ that is still available in terms of value and amount.

Alternatively or in combination therewith, these markings 23, 23′ implemented as measurements 26 or the affixed markings 23, 23′ that comprise measurements 26 may also signal the adjusting stroke 25 that has already been travelled. Such measurements 26 can, in particular, indicate to the rescuer 2 to what extent the at least one piston rod 7, 7′ has already been extended relative to the cylinder tube 6. In this context, it is particularly expedient if at least one maximum value 27—FIGS. 1, 2—is provided on the rescue device 1, in particular on its cylinder tube 6 and/or on the casing surface 22, 22′ of the at least one piston rod 7, 7, which indicates the maximum adjusting stroke 11 or the total movement path of the at least one piston rod 7, 7′, or defines the maximum achievable total length of the rescue device 1. Based on such plain text measurements 26 regarding the adjusting stroke 25 already travelled, the rescuer 2 can also gain an idea of what remaining stroke 24—FIG. 1—is still available. For this purpose, the rescuer 2 subtracts the adjusting stroke 25 already travelled from the maximum value 27 so that the rescuer 2 likewise knows the available remaining stroke 24 or the available thrust or push distance.

It is, however, more advantageous or expedient if the measurements 26 on the surface or on the casing surface 22, 22′ of the at least one piston rod 7, 7′ directly indicate or directly signal the respective available remaining stroke 24 with regard to extension movements 12 of the at least one piston rod 7, 7′, for example by means of symbols and/or by means of plain text or measurements 26.

The preferably provided values or measurements 26 on the at least one piston rod 7, 7′ can thereby comprise numerical values and measurement units, as illustrated in FIG. 6 by way of example. The markings 23, 23′ or the measurements 26 on the at least one piston rod 7, 7′ can also be implemented in the manner of a measurement chart or scale 31 (FIG. 6, FIG. 7), in which some markings 23, 23′ are indicated without measurements while other markings 23, 23′ do feature corresponding measurements, in particular at least numerical values. It is, in particular, also possible that the measurements 26 comprise only numerical values and a repeated indication of measurement units such as millimeters, centimeters, decimeters, inches or the like are unnecessary.

The markings 23, 23′ can alternatively or in combination with numerical values and/or measurements 26 also comprise marker rings or line marks 28 that extend partially or fully across the cross-sectional or casing circumference of the at least one piston rod 7, 7′, as depicted by way of example in FIGS. 5, 6. In particular, such line marks 28 can extend across the entire circumference of the casing (FIG. 6) and thus be implemented in a self-contained manner. This facilitates readability from almost all perspectives with regard to the at least one piston rod 7, 7′. It is alternatively also possible to implement offset or partially extending line marks 28 as illustrated in FIG. 5. In this way, the operating or labelling expenses can be kept relatively low and good readability or detectability from many perspectives or operating angles are accomplished nevertheless.

In order to be able to get a good overview of the available remaining stroke or the adjusting stroke 25 already travelled, it is advantageous if several markings 23, 23′ are implemented with regard to the longitudinal axis of the at least one piston rod 7, 7′ that are spaced apart at regular or irregular distances, as can be gathered from FIGS. 1, 3, 4, 5 and 6. In order to minimize labelling and marking expenses, it may also be provided that, with regard to the cross-sectional or casing circumference of the at least one piston rod 7, 7′, at least two, preferably three or four identically designed markings are applied that are equally distributed with regard to the same cross-sectional or casing circumference. Labelling or marking the at least one piston rod 7, 7′ entirely is thus rendered unnecessary and good detectability of the corresponding markings 23, 23′ can be achieved regardless of the angular position or perspective taken with regard to the rescue device 1.

It is thus set forth that the markings 23, 23′ may be formed by signs or symbols and/or by means of measurements 26. The corresponding markings 23, 23′ are implemented in a manner that contrasts in color and is flush-mounted with the surface of the at least one piston rod 7, 7′. The markings 23, 23′ can, however, also comprise arrow-shaped, bar-shaped or cuneiform symbols 29, which symbols 29 represent or signal the available remaining stroke 24 of the at least one piston rod 7, 7′.’ These symbols 29 can, in the style of the markings, then be implemented in the context of intensities or volume control based on the designations, as is shown, for example, in FIG. 8. Such a symbol 29, as FIG. 8 schematically depicts, can have a triangular or cuneiform shape. It is expedient in this regard if, as depicted in FIG. 8, at least three or four cuneiform or arrow symbols distributed across the cross-sectional perimeter of the casing surface 22, 22′ are implemented. It is further possible to provide four arrow or cuneiform symbols 29 extending across the cross-sectional circumference and in particular to form the symbols 29 within an angular range of 90° in each case. The preferably connected base lines 30 of these cuneiform or arrow-shaped symbols 29 thereby define the maximally extended state of the at least one piston rod 7, 7′ or the reaching or presence of the end or maximum position 10 (FIG. 1) of the at least one piston rod 7, 7′.

Furthermore, as illustrated in FIG. 7, a type of range or scale 31 can be provided which signals the available remaining stroke 24 in several stages. The individual stages in the available remaining stroke 24 can thereby be defined by line marks 28 of various lengths and/or by corresponding measurement specifications 26, in particular by millimeter and centimeter specifications. Accordingly, it can be provided that a comparatively higher distance resolution of the available remaining stroke 24 can be provided in particular in the last section of the total or maximum available adjusting stroke 11 of the at least one piston rod 7, 7′—FIG. 1—compared to the initial section of the total available adjusting stroke 11. In particular, as depicted by way of example in FIGS. 7, 8, a comparatively higher resolution regarding the final remaining stroke 24 may be provided with regard to the final distance than with regard to the distance resolution in this initial section of the total available adjusting stroke 11. In particular, the final adjusting stroke or the final remaining stroke 24 can be provided with a distance resolution in centimeters or millimeters (FIG. 7) or a corresponding symbolic designation of the final distance to the impact-limited or maximum extension position of the at least one piston rod 7, 7′.

The maximum available adjusting stroke 11 of a practicable hydraulic rescue device 1, in particular a hydraulic rescue device 1 operable by only one person, usually amounts to between 300 mm and 1000 mm. Its adjusting or compression force can amount to up to 300 kN. Correspondingly, rescue device 1 can thus be used in a number of accident scenarios or in a number of recovery operations from vehicles involved in accidents. The markings 23, 23′ on the at least one casing surface 22, 22′ of the at least one piston rod 7, 7′ can thereby be arranged at a distance of 50 mm or 100 mm with regard to the longitudinal direction of the at least one piston rod 7, 7′ or can be provided at a distance of one inch. A maximum distance resolution of the markings 23, 23′ or the scale 31 preferably amounts to 10 mm. This means that the labelling and marking expenses can be kept to a minimum and a sufficient information content for the rescuer 2 can still be achieved.

The markings 23, 23′ can particularly be formed by annealing colors, which annealing colors are applied to the metallic surface sections of the at least one piston rod 7, 7′ by way of thermal impact. In particular, laser beam processing can be provided with which permanent or abrasion-resistant markings 23 or labels can be applied to the casing sections 22, 22′ of the at least one piston rod 7, 7′. The surface of the at least one piston rod 7, 7′ can, in particular, be formed by a chromed or chrome-plated surface, as is typical of piston surfaces for hydraulic cylinders 5. It is also possible that markings 23, 23′ are applied to the metallic surface sections of the at least one piston rod 7, 7′ by way of electrochemical, in particular by way of galvanic processing methods. Such marking methods are known from the prior art and can, for example, by defined by a tampon galvanizing method or by an etching process.

The embodiments show possible variants, wherein it should be noted at this point that the invention is not limited to the specifically depicted variants of said invention, but rather that various combinations of the individual variants with each other are possible and that this possibility of variation lies within the abilities of the skilled person working in this technical field due to the doctrine of technical practice by means of a concrete invention.

The scope of protection is determined by the claims. However, the description and the drawings have to be consulted for interpreting the claims. Individual features or combinations of features from the various depicted and described embodiments can represent separate inventive solutions for themselves. The object underlying the separate inventive solutions can be gathered from the description.

All information on value ranges in the present description is to be understood to the effect that they also comprise any and all sub-ranges thereof, e.g. the information 1 to 10 is to be understood to the effect that all sub-ranges starting from the bottom limit 1 and the top limit 10 are comprised, i.e. all sub-ranges start at the bottom limit of 1 or greater and end at a top limit of 10 or smaller, e.g. 1 to 1.7 or 3.2 to 8.1 or 5.5 to 10.

For the sake of good order, it should finally be pointed out that, for better understanding of the structure, elements are sometimes not depicted to scale and/or are depicted in a magnified and/or reduced view.

### LIST OF REFERENCE NUMBERS

1 rescue device

2 rescuer

3 coupling device

4 line connection

5 hydraulic cylinder

6 cylinder tube

7, 7′ piston rod

8 starting or idle position

9 operating position

10 end or maximum position

11 maximum adjusting stroke

12 extension movement

13 retraction movement

14 control valve

15 actuating member

16 actuating member

17 first support surface

18 profile

19 second support surface

20 pressure piece

21 profile

22, 22′ casing surface

23, 23′ marking

24 remaining stroke

25 adjusting stroke travelled

26 measurement

27 maximum value

28 line mark

29 symbol

30 base line

31 scale

hydraulic line

1. A hydraulic rescue device (1) for manual operation by a rescuer (2), comprising a hydraulic cylinder (5) comprising a cylinder tube (6) and at least one piston rod (7, 7′) that can be adjusted relative to the cylinder tube (6), at least one first support surface (17) formed on the cylinder tube (6) for supporting the rescue device (1) in a load-transferring manner on first object surfaces that can be freely selected by a rescuer, at least one second support surface (19) for supporting the rescue device (1) in a load bearing manner that can be freely selected by a rescuer, and at least one control valve (14) that can be operated manually for the optional initiation and termination of adjusting movements of the at least one piston rod (7, 7′) relative to the cylinder tube (6), wherein at least one or more markings (23, 23′), which can be read by a rescuer (2), are formed on the casing surface (22, 22′) of the at least one piston rod (7, 7′), which at least one marking (23, 23′) is provided at least to signal a remaining stroke (24) that is still available of the at least one piston rod (7, 7′) relative to the cylinder tube (6).

2. The hydraulic rescue device according to claim 1, wherein several markings (23, 23′) are formed that are spaced apart with respect to the longitudinal axis of the at least one piston rod (7, 7′).

3. The hydraulic rescue device according to claim 1, wherein the markings (23, 23′) comprise measurements (26), which measurements (26) indicate the remaining stroke (24) that is still available of the at least one piston rod (7, 7′).

4. The hydraulic rescue device according to claim 1, wherein the markings (23, 23′) comprise arrow-shaped, bar-shaped or cuneiform symbols (29), which symbols (29) respectively indicate the remaining stroke (24) that is still available of the at least one piston rod (7, 7′).

5. The hydraulic rescue device according to claim 1, wherein the markings (23, 23′) are provided for signaling the remaining stroke (24) of the at least one piston rod (7, 7′) that is still available in terms of value or amount relative to the first support surface (17) at the cylinder tube (6).

6. The hydraulic rescue device according to claim 1, wherein the markings (23, 23′) comprise marker rings or line marks (28) extending at least partially across the cross-sectional or casing circumference of the at least on piston rod (7, 7′).

7. The hydraulic rescue device according to claim 1, wherein at least two, preferably at least three markings (23) and/or measurements (26) that are designed identically are indicated with respect to the cross-sectional or casing circumference of the at least one piston rod (7, 7′), which are equally spread across the cross-sectional or casing diameter.

8. The hydraulic rescue device according to claim 1, wherein the markings (23, 23′) are designed in contrasting colors and flush-mounted with regard to the surface of the at least one piston rod (7, 7′).

9. The hydraulic rescue device according to claim 1, wherein the markings (23, 23′) are formed by annealing colors, which annealing colors are applied to metallic surface sections of the at least one piston rod (7, 7′) by thermal impact and are in particular produced by laser beam processing.

10. The hydraulic rescue device according to claim 1, wherein the markings (23, 23′) are applied to metallic surface sections of the at least one piston rod (7, 7′) by means of electrochemical, in particular by means of galvanic processing methods.

11. The hydraulic rescue device according to claim 1, wherein its maximum available adjusting stroke (11) is between 300 mm and 1,000 mm and the markings (23, 23′) are arranged at a distance of 50 mm or 100 mm with respect to the longitudinal direction of the at least one piston rod (7, 7′).

12. The hydraulic rescue device according to claim 1, wherein a comparably higher information density or denser distribution of the markings (23, 23′) is provided for in the last section of the total available adjusting stroke (11) of the at least one piston rod (7, 7′) regarding the remaining stroke (24) compared to the initial section of the total available adjusting stroke (11), or wherein there is a comparably higher information resolution across the final distance travelled by the at least one piston rod (7, 7′).
